(19) United States
(12) Patent Application Publication
(10) Pub. No.: US 2012/0203857 A1
(43) Pub. Date: Aug. 9, 2012

(54) Short-Message Transfer Method, Subsystem and System

(75) Inventors: Xiuying Wu, Shenzhen (CN); Liangjia Wang, Shenzhen (CN)

(73) Assignee: ZTE CORPORATION, Shenzhen City, Guangdong Province (CN)

(21) Appl. No.: 13/502,616

(22) PCT Filed: Dec. 24, 2009
(86) PCT No.: PCT/CN09/76009

§ 371 Date: Apr. 18, 2012

(30) Foreign Application Priority Data
Oct. 20, 2009 (CN) 200910205519.2

(51) Int. Cl. G06F 15/16

(52) U.S. Cl. 709/206

(57) ABSTRACT

The present invention discloses a short message transfer method, subsystem and system. It relates to the field of value-added service and solves the problem of poor flexibility of short message transfer systems. The method includes: receiving a status report message of a transfer service short message transmitted by a destination short message center; querying a transfer number corresponding to a destination number of the transfer service short message when the status report message indicates that the transfer service short message is delivered unsuccessfully; and replacing the destination number of the transfer service short message with the transfer number, and transmitting the transfer service short message to a transfer short message center. The technical solution of the present invention realizes the conditional transfer of short messages.

### TECHNICAL FIELD

The present invention relates to the field of value-added services, and more especially, to a short message transfer method, apparatus and system.

### BACKGROUND OF THE RELATED ART

With the significant upgrade of the mobile terminal popularity and the rapid development of the short message value-added services, communication through short messages is becoming indispensable communication means in people's daily works and lives. The necessary conditions for a mobile terminal to receive a short message are: the terminal is not suspended, the terminal is not powered on, and the terminal is in the network coverage etc. In real lives, sometimes the mobile terminal users may inevitably make the terminal not be used due to various reasons. The short message transfer service a short message value-added service which is put forward based on the above situation. It achieves successfully issuing a short message by transferring the short message to a third number so that the original terminal forwards the short message to the third number in the case that the original terminal cannot receive short message.

The short message transfer service usually takes a absolute transfer method, that is, when the number A opens the short message transfer service, the short messages transmitted to the number A will be unconditionally transferred to a transfer number set by the number A. On this basis, a time period transfer method can further be added, that is, the short messages transmitted to the number A within an effective transfer time period are unconditionally transferred to the transfer number set by the number A.

In the abovementioned short message transfer process, there are the following problems:

activation or deactivation of a short message service of a number can only be pre-set by the user, and for a number which is in a short message transfer service activation state, all the short messages transmitted to the number will be transferred to a transfer number, which results in poor system flexibility.

### SUMMARY OF THE INVENTION

The present invention provides a short message transfer method, apparatus and system to solve the problem of poor flexibility of the short message transfer system.

To achieve the aforementioned purpose, the technical solution of the present invention is implemented as follows.

The present invention provides a short message transfer method, comprising:

receiving a status report message of a transfer service short message transmitted by a destination short message center;

querying a transfer number corresponding to a destination number of the transfer service short message when the status report message indicates that the transfer service short message is delivered unsuccessfully; and

replacing the destination number of the transfer service short message with the transfer number, and transmitting the transfer service short message to a transfer short message center.

Furthermore, before receiving the status report message of the transfer service short message transmitted by the destination short message center, the method further comprises:

receiving a short message transmitted by a source short message center;

if the destination number of the short message opens a transfer service, determining that the short message is a transfer service short message;

determining whether the destination number of the transfer service short message is currently in an absolute transfer state or a conditional transfer state;

if the destination number of the transfer service short message is currently in a conditional transfer state, delivering the transfer service short message to the destination short message center; or,

if the destination number of the transfer service short message is currently in an absolute transfer state, transmitting the transfer service short message to the transfer short message center.

Furthermore, delivering the transfer service short message to the destination short message center specifically comprises:

delivering the transfer service short message to the destination short message center, and indicating the destination short message center to deliver the transfer service short message for only once and returning a status report message; or,

delivering the transfer service short message to the destination short message center, and indicating the destination short message center to deliver the transfer service short message by means of repeatedly delivering and returning a status report message.

Furthermore, the short message transfer method further comprises:

if the status report message indicates that the transfer service short message is delivered successfully, transmitting a status report message to the source short message center of the transfer service short message to indicate that the transfer service short message is delivered successfully.

Furthermore, after the step of replacing the destination number of the transfer service short message with the transfer number and transmitting the transfer service short message to the transfer short message center, the method further comprises:

receiving the status report message transmitted by the transfer short message center;

if the status report message indicates that the transfer service short message is delivered successfully to the transfer number, constructing and transmitting a successful status report message to the source short message center; or

if the status report message indicates that the transfer service short message is delivered unsuccessfully to the transfer number, constructing and transmitting an unsuccessful status report message to the source short message center.

The present invention further provides a short message transfer subsystem, comprising:

an interface machine module, configured to receive a status report message of a transfer service short message transmitted by a destination short message center;

a service processing module, configured to query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center via the interface machine module.

Furthermore, the interface machine module is further configured to receive a short message transmitted by a source short message center, determine whether the short message is a transfer service short message or not, and forward the transfer service short message to the service processing module; and

the service processing module is further configured to determine whether the destination number of the transfer service short message is currently in an absolute transfer state or a conditional transfer state, deliver the transfer service short message to the destination short message center when the destination number of the transfer service short message is currently in a conditional transfer state; or transmit the transfer service short message to the transfer short message center when the destination number of the transfer service short message is currently in an absolute transfer state.

Furthermore, the interface machine module is further configured to receive a status report message transmitted by the transfer short message center;

the service processing module is further configured to:

construct and transmit a successful status report message to the source short message center via the interface machine module when the status report message indicates that the transfer service short message is delivered successfully to the transfer number; or,

construct and transmit an unsuccessful status report message to the source short message center via the interface machine module when the status report message indicates that the transfer service short message is delivered unsuccessfully to the transfer number.

The present invention further provides a short message transfer system comprising a short message transfer subsystem, configured to receive a status report message of a transfer service short message transmitted by a destination short message center, query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center.

Furthermore, the short message transfer subsystem is further configured to receive a transfer service short message transmitted by a source short message center and determine whether a destination number of the transfer service short message is currently in an absolute transfer state or a conditional transfer state, and deliver the transfer service short message to the destination short message center when the destination number of the transfer service short message is currently in a conditional transfer state; or,

when the destination number of the transfer service short message is currently in an absolute transfer state, transmit the transfer service short message to the transfer short message center.

The present invention provides a short message transfer method, apparatus and system, which queries a transfer number corresponding to a number supporting short message transfer services when a transfer service short message is transmitted to the number supporting short message transfer services and is delivered unsuccessfully, and retransmits the transfer service short message to the transfer number, that is, the transfer service short message is forwarded to the transfer number only when the number is unreachable, thus achieving the conditional transfer of the short message and improving the flexibility of the short message transfer system.

### BRIEF DESCRIPTION OF DRAWINGS

FIG. 1 is a structural diagram of a network in an application environment in accordance with an embodiment of the present invention;

FIG. 2 is a diagram of an internal structure of a short message transfer subsystem 101 in FIG. 1;

FIG. 3 is a diagram of an internal structure of a service processing module 203 in FIG. 2;

FIG. 4 is a flow chart of a short message transfer method provided in a first embodiment of the present invention;

FIG. 5 is a flow chart of a short message transfer method provided in a second embodiment of the present invention;

FIG. 6 is a structural diagram of a short message transfer subsystem provided in an embodiment of the present invention; and

FIG. 7 is a structural diagram of a short message transfer system provided in an embodiment of the present invention.

### PREFERRED EMBODIMENTS OF THE PRESENT INVENTION

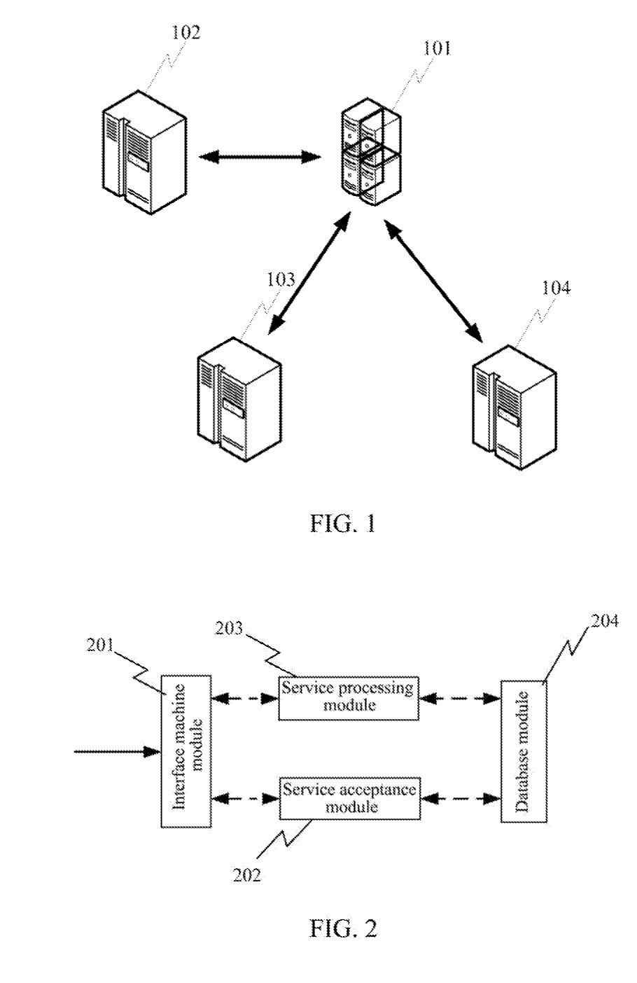

In order to solve the problem of poor flexibility of a short message transfer system, a first embodiment of the present invention provides a short message transfer method. An application environment in accordance with the embodiment of the present invention is shown in FIG. 1, comprising a short message transfer subsystem 101, a source short message center 102, a destination short message center 103 and a transfer short message center 104; wherein, a destination number of a transfer service short message is under the destination short message center 103, and a transfer number of the number is under the transfer short message center 104.

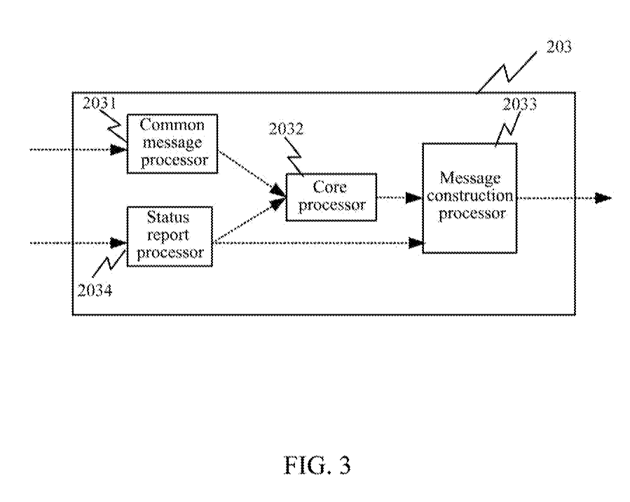

Furthermore, an internal structure of the short message transfer subsystem 101 in FIG. 1 is shown in FIG. 2, comprising: an interface machine module 201, a service acceptance module 202, a service processing module 203 and a database module 204.

Wherein, the service processing module 203 is shown in FIG. 3, comprising: a common message processor 2031, a core processor 2032, a message construction processor 2033 and a status report processor 2034.

The interface machine module 201 is responsible for receiving all messages from the short message center, and converting the external messages into an unified internal message format, to enable the system flexibly extend different message communication protocols; and then determining the messages of the unified internal format based on the message type, i.e., if the message is a service acceptance message, such as a status report message, a transfer service short message, and so on, the message is delivered to the service acceptance module 202, and otherwise the message is delivered to the service processing module 203; and in addition, the interface machine module further has a transfer function, i.e., converting the messages of the internal format into external messages and forwarding the external messages.

The service acceptance module 202 is responsible for opening and cancelling an account of the short message transfer service as well as configuring features of a specific user service.

The service processing module 203 firstly processes a received message in the common message processor 2031 when receiving the common uplink message which then enters the core processor 2032, determines a trigger mode of the transfer service, i.e., an absolute transfer or a conditional transfer; after determining that the message needs to be delivered directly to the destination short message center, the core processor 2032 sets that the message needs a status report and meanwhile indicates to the short message center whether the short message needs to be delivered repeatedly and a status report is returned eventually, or the short message only needs to be delivered for the first time and a status report is constructed according to a first delivery result and returned to the short message transfer subsystem; and the message construction processor 2033 constructs a message according to a processing result of the core service processor 2032.

After receiving the status report, the service processing module 203 processes the received status report in the status report processor 2034, the status report processor 2034 determines the message transmitting result, and if the message is transmitted successfully, the message construction processor 2033 is notified to construct and deliver a successful status report to the source short message center; otherwise, the status report processor 2034 determines whether the message is a status report returned by the destination short message center after the original short message is issued, and if the message is the status report, the message is delivered to the core processor 2032 and the core processor 2032 queries a transfer number corresponding to the destination number on the basis that this status report is the one returned by the destination short message center after the original message is issued, and meanwhile, after it is indicated for the short message center that the message needs to be repeatedly delivered, the process proceeds to the message construction processor 2033, and the message construction processor 2033 constructs a message to issue. Otherwise, the status report processor 2034 determines that the message is a status report of a message issued to the transfer number, and notifies the message construction processor 2033 to construct and deliver a status report to the source short message center.

The database module 204 comprises a memory database and a physical database, wherein, the memory database is mainly used to transfer the related information that needs to be stored in a transfer service trigger process; and the physical database stores basic information of the user and the service triggering information.

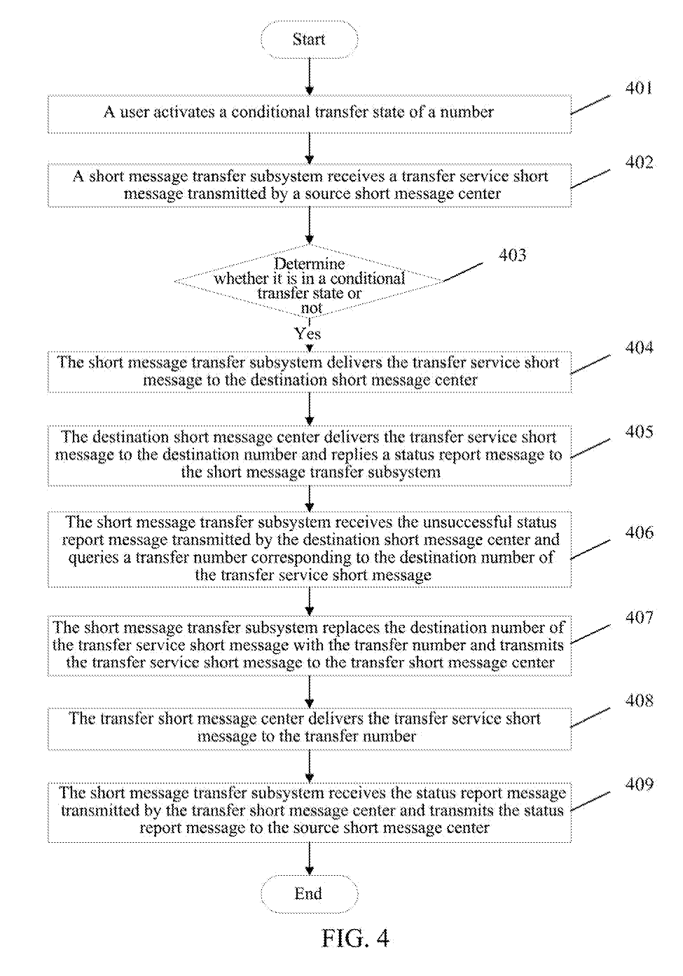

The process of implementing the short message transfer using the method is shown in FIG. 4, comprising the following steps.

In step 401, a user activates a conditional transfer state of a number.

In the embodiments of the present invention, two states are specified for a short message transfer service, i.e., an absolute transfer state and a conditional transfer state. Under the absolute transfer state, all short messages transmitted to the number will be transferred to the transfer number; and under the conditional transfer state, the short message is forwarded to the transfer number only when the number is unreachable.

In this step, the user firstly activates the short message transfer state of the number, specifically the conditional transfer state, after that, the number is in the conditional transfer state, and when the number is unreachable, the short message transmitted to the number will be transferred to the transfer number.

In step 402, the short message transfer subsystem receives the transfer service short message transmitted by the source short message center.

In this step, after receiving the short message transmitted by the source short message center, the short message transfer subsystem queries whether the destination number of this short message opens a short message transfer service or not, and if the number opens a short message transfer service, the short message is considered as a transfer service short message, that is, the transfer service short message will be transferred to the transfer number of the destination number when the destination number is unreachable.

In step 403, the short message transfer subsystem determines whether the destination number of the transfer service short message is currently in a conditional transfer state or not.

In step 404, if the destination number of the transfer service short message is currently in a conditional transfer state, the short message transfer subsystem delivers the transfer service short message to the destination short message center.

In this step, according to the determination result in step 403, if the destination number of the transfer service short message is currently in a conditional transfer state, it is indicated that the transfer service short message can be delivered to the transfer number if it is delivered unsuccessfully to the destination number, and therefore, the transfer service short message is firstly delivered to the destination short message center, and the destination short message center is indicated to deliver the transfer service short message for only once and return a status report message to report whether the transfer service short message is delivered successfully or unsuccessfully.

In addition, if the user activates an absolute transfer state of the destination number in step 401, that is, the destination number of the transfer service short message is currently not in a conditional transfer state, it is indicated that all short messages transmitted to the destination number need to be unconditionally transferred to the transfer number, and in this step, the transfer service short messages will be directly transmitted to the transfer short message center.

In step 405, the destination short message center delivers the transfer service short message to the destination number and replies a status report message to the short message transfer subsystem.

In this step, the destination short message center delivers the received transfer service short message to the destination number, and if the received transfer service short message is delivered unsuccessfully, constructs an unsuccessful status report message; and if the received transfer service short message is delivered successfully, constructs a successful status report message. The status report message is replied to the short message transfer subsystem

In the embodiment of the present invention, it is illustrated by example of an unsuccessful delivery, and after receiving the unsuccessful status report message, the destination short message center needs to transmit an unsuccessful status report message to the short message transfer subsystem, and then the short message transfer subsystem transmits the unsuccessful status report message to the source short message center.

In step 406, the short message transfer subsystem receives the unsuccessful status report message transmitted by the destination short message center, and queries the transfer number corresponding to the destination number of the transfer service short message.

In step 407, the short message transfer subsystem replaces the destination number of the transfer service short message with the transfer number and transmits the transfer service short message to the transfer short message center.

In step 408, the transfer short message center delivers the transfer service short message to the transfer number.

In step 409, the short message transfer subsystem receives the status report message transmitted by the transfer short message center and transmits the status report message to the source short message center.

In this step, the transfer short message center firstly receives the status report message returned by the transfer number, determines whether the delivery is successful or not according to the status report message, and constructs a successful or unsuccessful status report message according to the delivery result and transmits the status report message to the short message transfer subsystem.

The short message transfer subsystem receives the status report message transmitted by the transfer short message center, determines whether the delivery is successful or not according to the status report message, and constructs a successful or unsuccessful status report message according to the delivery result and transmits the status report message to the source short message center.

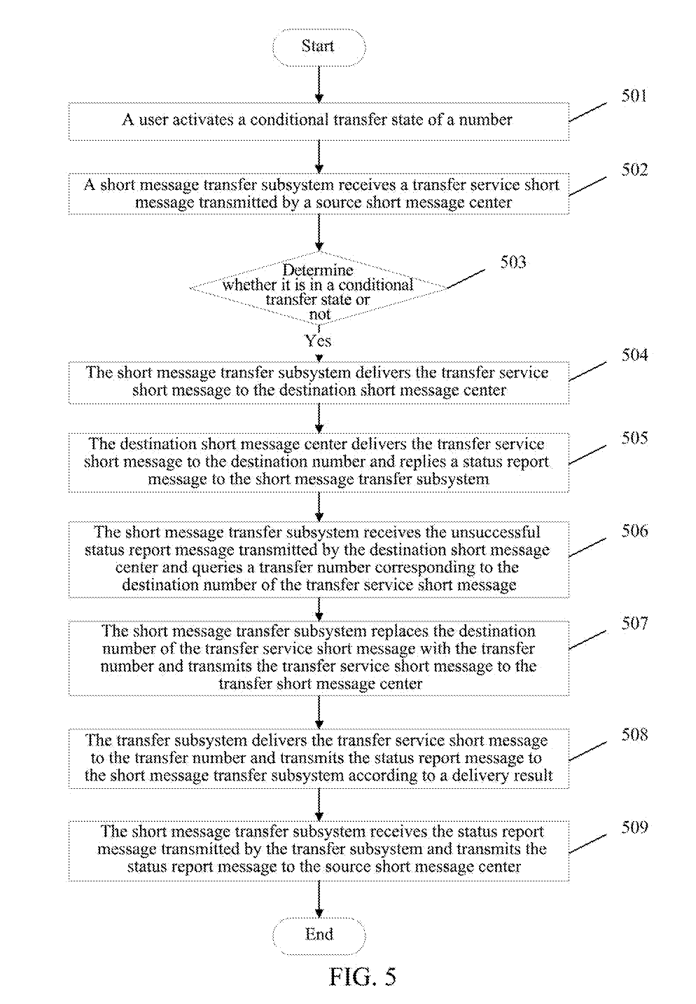

The second embodiment of the present invention will be described in combination with accompanying drawings hereinafter. The process of implementing conditional transfer using a short message transfer method provided in the embodiment of the present invention is shown in FIG. 5, wherein, steps 501 to 503 are the same as steps 401 to 403 in the first embodiment of the present invention and will not be described.

In step 504, if the destination number of the transfer service short message is currently in a conditional transfer status, the short message transfer subsystem delivers the transfer service short message to the destination short message center.

In this step, according to the determination result in step 503, if the destination number of the transfer service short message is currently in a conditional transfer state, it is indicated that the transfer service short message can be delivered to the transfer number when the message is delivered unsuccessfully to the destination number, and therefore, firstly the transfer service short message is delivered to the destination short message center, and the destination short message center is indicated to deliver the transfer service short message by means of repeatedly delivering, i.e., reattempting to deliver when the delivery is unsuccessful (a number of attempts is determined by the transfer short message center), and constructs a status report message according to the final delivery result and transmits the status report message to the short message transfer subsystem.

In step 505, the destination short message center delivers the transfer service short message to the destination number and replies a status report message to the short message transfer subsystem.

In this step, the destination short message center repeatedly delivers the received transfer service short message to the destination number, and constructs the status report message in accordance with the final delivery result, and if the delivery is unsuccessful, constructs an unsuccessful status report message; and if the delivery is successful, constructs a successful status report message. The status report message is replied to the short message transfer subsystem.

If the delivery is successful, after receiving the successful status report message, the destination short message center transmits the directly constructed successful status report message to the source short message center; and if the delivery is unsuccessful, after receiving the unsuccessful status report message, the destination short message center needs to transmit the unsuccessful status report message to the source short message center.

Steps 506 to 509 are the same as steps 406 to 409 in the embodiment of the present invention and will not be described.

It should be illustrated that in the embodiments of the present invention, the transfer service short message is a point to point short message, except that the destination number of the short message is a number that opens a transfer service; and the transfer short message center and the destination short message center can be two different short message centers or can also be the same short message center (that is, the destination number and the transfer number are numbers under the same short message center).

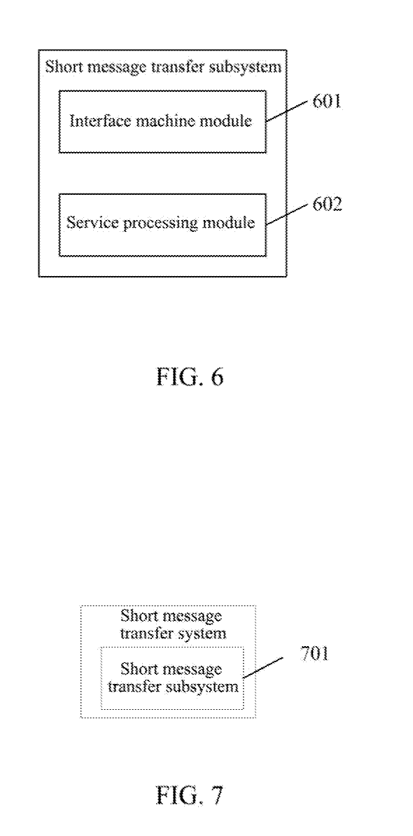

The embodiment of the present invention further provides a short message transfer subsystem, and the structure of the short message transfer subsystem is shown in FIG. 6, which comprises the following modules.

The interface machine module 601 is configured to receive a status report message of a transfer service short message transmitted by a destination short message center.

The service processing module 602 is configured to query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center via the interface machine module 601.

Furthermore, the interface machine module 601 is further configured to receive a short message transmitted by a source short message center, and determine whether the short message is a transfer service short message or not, and forward the transfer service short message to the service processing module 602.

The service processing module 602 is further configured to determine whether the destination number of the transfer service short message is currently in an absolute transfer state or a conditional transfer state, and deliver the transfer service short message to the destination short message center when the destination number of the transfer service short message is currently in a conditional transfer status, or transmit the transfer service short message to the transfer short message center when the destination number of the transfer service short message is currently in an absolute transfer state.

Furthermore, the interface machine module 601 is further configured to receive a status report message transmitted by the transfer short message center.

The service processing module 602 is further configured to construct and transmit a successful status report message to the source short message center via the interface machine module 601 when the status report message indicates that the transfer service short message is delivered successfully to the transfer number; or,

construct and transmit an unsuccessful status report message to the source short message center via the interface machine module 601 when the status report message indicates that the transfer service short message is delivered unsuccessfully to the transfer number.

The process of completing the short message transfer using the above short message transfer subsystem is as follows: firstly, the receiver module 601 receives a short message transmitted by the source short message center and determines whether the short message is a transfer service short message or not; in the case that the short message is determined as a transfer service short message, transmits the transfer service short message to the service processing module 602; and the service processing module 602 further determines whether the current service state of the destination number of the transfer service short message, and when the destination number is in a conditional transfer state, firstly delivers the transfer service short message to the destination short message center, and when the delivery is unsuccessful, queries the transfer number of the destination number of the transfer service short message, and delivers the short message to the transfer number.

The embodiment of the present invention further provides a short message transfer system, as shown in FIG. 7, comprising a short message transfer subsystem 701, configured to receive a status report message of a transfer service short message transmitted by a destination short message center, and query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center.

Furthermore, the short message transfer subsystem 701 is further configured to receive a transfer service short message transmitted by a source short message center and determine whether the destination number of the transfer service short message is currently in an absolute transfer state or a conditional transfer state, and when the destination number of the transfer service short message is in a conditional transfer state, deliver the transfer service short message to the destination short message center; or

when the destination number of the transfer service short message is in an absolute transfer status, deliver the transfer service short message to the transfer short message center.

When delivering the transfer service short message, according to the indication of the short message transfer subsystem, the destination short message center delivers the transfer service short message for only once and returns a status report message; or

delivers the transfer service short message by means of repeatedly delivering and returns a status report message.

The above short message transfer subsystem and short message transfer system can be combined with a short message transfer method provided in the embodiment of the present invention, which queries the transfer number corresponding to the number supporting short message transfer services when the transfer service short message is transmitted to the number supporting short message transfer services and is delivered unsuccessfully, retransmits the transfer service short message to the transfer number, i.e., forwarding the transfer service short message to the transfer number only when the number is unreachable, thus achieving the conditional transfer of the short message and improving the flexibility of the short message transfer system.

A person having ordinary skill in the art can understand that all or a part of the steps carried in the method for achieving the aforementioned embodiments can be implemented by a program instructing related hardware, and the program can be stored in a computer readable storage medium, and when executed, the program comprises one of the steps of the method embodiment, or a combination thereof.

In addition, various functional units in various embodiments of the present invention can be implemented in a form of hardware, or can also be implemented in a form of software functional modules. If implemented in the form of software functional modules and sold or used as an individual product, the integrated modules can also be stored in a computer readable storage media.

The aforementioned storage media can be a read-only memory, a disk or a CD-ROM etc.

The above description is only the specific embodiments of the present invention, and the protection scope of the present invention is not limited to the above description. Any skilled in the art can easily think of changes or substitutions within the technique scope disclosed in the present invention, which should be covered within the protection scope of the present invention. Therefore, the protection scope of the present invention should be based on the protection scope described in the claims.

What is claimed is:

1. A short message transfer method, comprising:
receiving a status report message of a transfer service short message transmitted by a destination short message center;
querying a transfer number corresponding to a destination number of the transfer service short message when the status report message indicates that the transfer service short message is delivered unsuccessfully;
replacing the destination number of the transfer service short message with the transfer number, and transmitting the transfer service short message to a transfer short message center.

2. The short message transfer method of claim 1, wherein, before receiving the status report message of the transfer service short message transmitted by the destination short message center, the method further comprises:
receiving a short message transmitted by a source short message center;
if the destination number of the short message opens a transfer service, determining that the short message is a transfer service short message;
determining whether the destination number of the transfer service short message is currently in an absolute transfer state or a conditional transfer state;
if the destination number of the transfer service short message is currently in a conditional transfer state, delivering the transfer service short message to the destination short message center; or,
if the destination number of the transfer service short message is currently in an absolute transfer state, transmitting the transfer service short message to the transfer short message center.

3. The short message transfer method of claim 1, wherein, delivering the transfer service short message to the destination short message center specifically comprises:
delivering the transfer service short message to the destination short message center, and indicating the destination short message center to deliver the transfer service short message for only once and returning a status report message; or,
delivering the transfer service short message to the destination short message center, and indicating the destination short message center to deliver the transfer service short message by means of repeatedly delivering and returning a status report message.

4. The short message transfer method of claim 1, further comprising:
if the status report message indicates that the transfer service short message is delivered successfully, transmitting a status report message to the source short message center of the transfer service short message to indicate that the transfer service short message is delivered successfully.

5. The short message transfer method of claim 1, wherein, after replacing the destination number of the transfer service short message with the transfer number and transmitting the transfer service short message to the transfer short message center, the method further comprises:
receiving the status report message transmitted by the transfer short message center;
if the status report message indicates that the transfer service short message is delivered successfully to the transfer number, constructing and transmitting a successful status report message to the source short message center; or
if the status report message indicates that the transfer service short message is delivered unsuccessfully to the transfer number, constructing and transmitting an unsuccessful status report message to the source short message center.

6. A short message transfer subsystem, comprising:
an interface machine module, configured to receive a status report message of a transfer service short message transmitted by a destination short message center;
a service processing module, configured to query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center via the interface machine module.

7. The short message transfer subsystem of claim 6, wherein,
the interface machine module is further configured to receive a short message transmitted by a source short message center, determine whether the short message is a transfer service short message or not, and forward the transfer service short message to the service processing module;
the service processing module is further configured to determine whether the destination number of the transfer service short message is currently in an absolute transfer state or a conditional transfer state, deliver the transfer service short message to the destination short message center when the destination number of the transfer service short message is currently in a conditional transfer state; or transmit the transfer service short message to the transfer short message center when the destination number of the transfer service short message is currently in an absolute transfer state.

8. The short message transfer subsystem of claim 6, wherein, the interface machine module is further configured to receive the status report message transmitted by the transfer short message center;
the service processing module is further configured to:
construct and transmit a successful status report message to the source short message center via the interface machine module when the status report message indicates that the transfer service short message is delivered successfully to the transfer number; or,
construct and transmit an unsuccessful status report message to the source short message center via the interface machine module when the status report message indicates that the transfer service short message is delivered unsuccessfully to the transfer number.

9. A short message transfer system, comprising a short message transfer subsystem, configured to receive a status report message of a transfer service short message transmitted by a destination short message center, query a transfer number corresponding to a destination number of the transfer service short message when the status report message indicates that the transfer service short message is delivered unsuccessfully, replace the destination number of the transfer service short message with the transfer number, and transmit the transfer service short message to the transfer short message center.

10. The short message transfer system of claim 9, wherein,
the short message transfer subsystem is further configured to receive the transfer service short message transmitted by a source short message center and determine whether a destination number of the transfer service short message is currently in an absolute transfer state or a conditional transfer state, and deliver the transfer service short message to the destination short message center when the destination number of the transfer service short message is currently in a conditional transfer state; or,
when the destination number of the transfer service short message is currently in an absolute transfer state, transmit the transfer service short message to the transfer short message center.

11. The short message transfer method of claim 2, wherein, delivering the transfer service short message to the destination short message center specifically comprises:
delivering the transfer service short message to the destination short message center, and indicating the destination short message center to deliver the transfer service short message for only once and returning a status report message; or,
delivering the transfer service short message to the destination short message center, and indicating the destination short message center to deliver the transfer service short message by means of repeatedly delivering and returning a status report message.
